(19) United States
(12) Patent Application Publication
(10) Pub. No.: US 2010/0175238 A1
(43) Pub. Date: Jul. 15, 2010

(54) Picket Installation Tool

(76) Inventor: Paul SMITH, Hillsville, VA (US)

Correspondence Address: NEW RIVER VALLEY INTELLECTUAL PROPERTY LAW, P.O. BOX 10944, BLACKSBURG, VA, 24062, US

(21) Appl. No.: 12/687,932

(22) Filed: Jan. 15, 2010

Related U.S. Application Data
(60) Provisional application No. 61/144,778, filed on Jan. 15, 2009.

(51) Int. Cl. B25B 27/14

(52) U.S. Cl. 29/281.5

(57) ABSTRACT

This invention relates generally to the field of tools for residential and commercial building construction. The invention provides tools for installing an object, such as deck railing pickets, while maintaining a desired and/or consistent spacing between the object and another object and allowing for hands-free holding during installation of the object to be installed. A particular embodiment of the invention includes A tool for hands-free installation of an object comprising: one or more supports comprising one or more recesses for accepting one or more objects, wherein said recesses and said objects are complementary shaped; wherein said recesses comprise means for holding said objects within said recesses; and wherein said recesses are spaced at a desired spacing interval.

### CROSS-REFERENCE TO RELATED APPLICATIONS

This application relies on the disclosure and claims the benefit of the filing date of U.S. Provisional Patent Application No. 61/144,778 Jan. 15, 2009, the disclosure of which is hereby incorporated by reference in its entirety.

### BACKGROUND OF THE INVENTION

1. Field of the Invention

This invention relates generally to the field of tools for residential and commercial building construction. The invention provides tools for installing an object, such as deck railing pickets, while maintaining a desired and/or consistent spacing between the object and another object and allowing for hands-free holding during installation of the object to be installed.

2. Description of the Related Art

Installation of pickets on deck railings is typically difficult to accomplish with a single worker. For example, a first worker is typically used to measure and determine the desired placement of the picket, taking into account applicable national, state, and/or local building codes, as well as maintaining a vertical level with other surrounding pickets. Once the desired placement is determined, the first worker temporarily holds the picket to be installed in the desired position, while a second worker fastens or secures the picket permanently in place, which often entails using other tools, such as a drill, hammer, or nail gun.

Installation often becomes cumbersome when loading the tools with a fastening means, such as a nail or screw, or when driving the fastening means into place because more than one hand is usually needed to accomplish this. Some workers may resort to holding the properly aligned picket with a knee or other part of the body, while using one hand to hold the fastening means (such as nail) in the desired position and the other hand for operating and holding the driver for the fastening means (hammer) in the other hand. Thus, it is difficult for a single worker to temporarily hold the properly placed picket in place while also using a drill, for example, to secure the picket in place with a screw. This method, however, can lead to shifting of the picket out of the desired position because the worker's knee cannot provide a sufficiently secure temporary grasp on the picket. If the placement shift goes unnoticed at first, such error can be propagated as subsequent pickets are installed, which are usually positioned based on the most recent picket installed.

Templates for aligning pickets also exist, but these have limitations as well. When using a template, typically, pickets are secured to the top and bottom railings in the template designed in accordance with the desired spacing between pickets. Then, the picket and railing unit is installed on the deck (or fence). Even in this situation, however, the issue still remains of how to hold the unit in place temporarily while it is installed. Also, such templates are not practical where only the pickets or a few pickets of an existing railing or fence need to be replaced. Also, when installing pickets on railing for stairs, the tops and bottom of the pickets will not be at the same height, rather, the tops and bottoms of the pickets will be expected to follow a line that has a slope according to the slope of the stairs. Thus, more than one template may be needed for projects with multiple gradients, which is especially common when installing fencing on land.

### SUMMARY OF THE INVENTION

The invention addresses these issues by providing a convenient and cost effective tool to enable a single worker to install fencing/deck pickets quickly and easily. The tool of the present invention is capable of reducing a two or more person job into a one-person job, which may in turn lead to a reduction in labor installation cost and the amount of time required to complete a construction project.

Embodiments of the invention include a tool for hands-free installation of an object comprising: means for accepting, holding, and spacing an object at a desired spacing interval.

Further included is a tool for hands-free installation of an object comprising: one or more supports comprising one or more recesses for accepting one or more objects, wherein said recesses and said objects are complementary shaped; wherein said recesses comprise means for holding said objects within said recesses; and wherein said recesses are spaced at a desired spacing interval.

Embodiments of the invention include a tool for hands-free installation of a picket comprising: two supports each comprising two recesses spaced about 4 inches apart, wherein said recesses comprise means for holding a picket within said recess; two receiving sleeves each having an interior surface shape complementary to an exterior surface shape of said supports for receiving said supports; means for securing said supports within said receiving sleeves; and a handle in communication with said receiving sleeves for maintaining said receiving sleeves and said supports parallel to and at a desired distance from one another.

### BRIEF DESCRIPTION OF THE DRAWINGS

FIG. 1A provides a perspective view of an embodiment of the invention, which is a picket installation tool.

FIG. 1B provides a perspective view of the picket installation tool embodiment shown also in FIG. 1A.

FIG. 2 provides an exemplary product formed by using the picket installation tool embodiment shown in FIGS. 1A & B, which is a deck railing.

FIG. 3A shows an embodiment of the object installation tool according to the invention, operably configured with a leveling device.

FIG. 3B shows an embodiment of the invention, namely an object installation tool with a handle and multiple object spacer/holder means.

FIG. 4 shows a representative spacing tool according to the invention.

FIGS. 5A-D show an embodiment of an object installation tool in accordance with the present invention and demonstrate the hands-free holding of a picket during installation.

FIGS. 6A-D show an exemplary embodiment of the object installation tool as it is used to install the pickets of a deck railing.

FIG. 7 shows a modular object installation tool embodiment of the invention.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

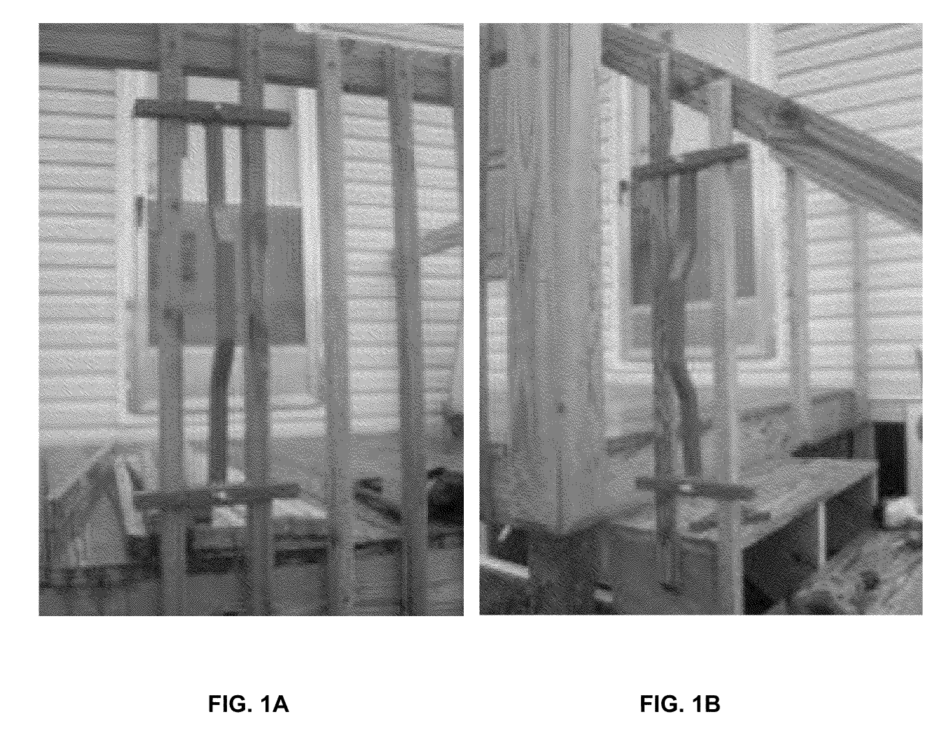

An embodiment of the invention is provided in FIGS. 1A and 1B, which are photos of the invention embodied in a picket installation tool. As shown in FIG. 1A, the picket installation tool can be used for quick, easy, hands-free holding of a picket during installation of the picket on a deck railing or fence. As shown in the photo of FIG. 1B, the tool can also be configured so as to provide for installation of pickets on deck railings that slope with stairs and/or fences that slope due to corresponding sloping ground surfaces.

As shown in FIG. 1B, the picket installation tool grips a first picket that is already installed on a deck railing. For example, in FIG. 1B, the previously installed picket (picket in left part of tool) is secured in place on the railing by screws toward the top and bottom of the picket. The picket installation tool grips the installed picket by way of means for accepting and holding the picket. In this embodiment, this accepting and holding means is represented by a recess in the top bar of the tool and a recess in the lower bar of the tool, which are aligned with one another in a line that is perpendicular to a horizontal line or plane. Said another way, the two supports at opposite ends of the handle are maintained at a desired lengthwise distance from one another and are maintained in parallel with one another. The picket installation tool also grips one or more pickets to be installed.

As shown in FIG. 1B, the picket on the right has no screws permanently securing the picket in place. The uninstalled picket is thus held in the picket spacer/holder by means for accepting and holding the picket, which can be similar to the means used to retain the installed picket as described above. The means for accepting and holding the picket can be configured so as to grip the pickets securely so that the picket will not move once positioned and held by the tool (for example, in the recess), however, some give may be desired in certain applications to allow for fine tuning of the placement of the picket to be installed.

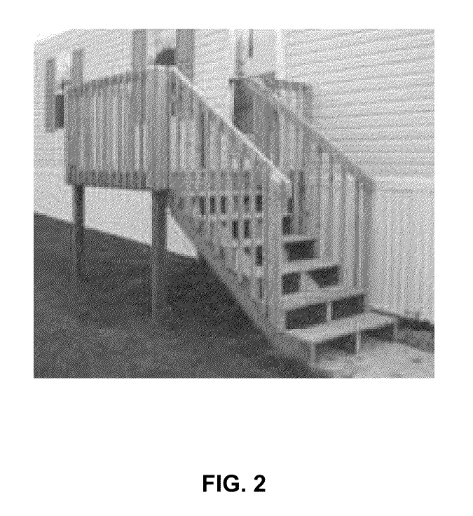

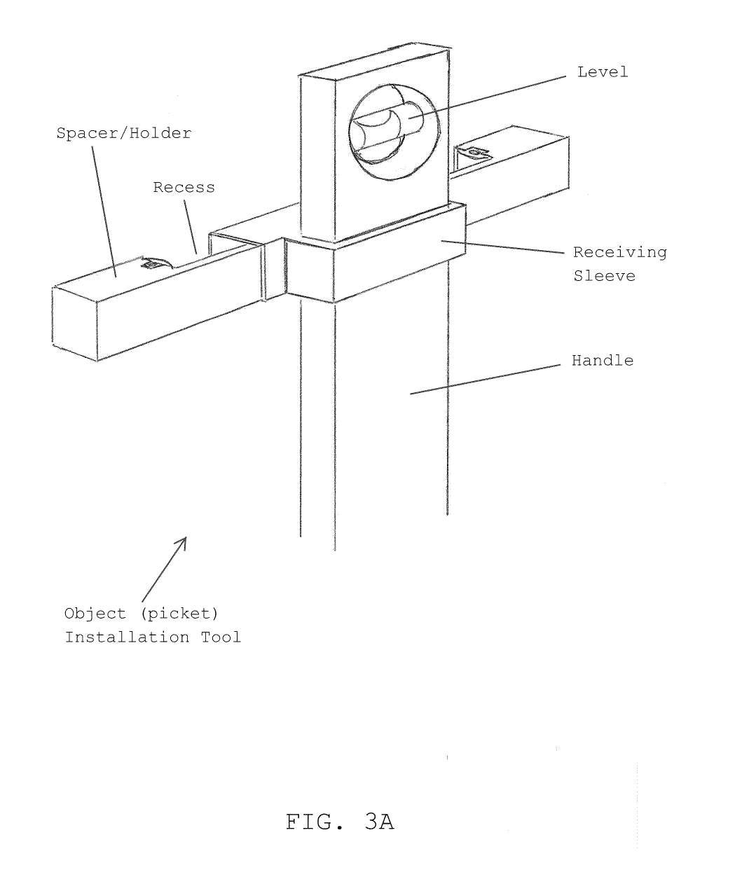

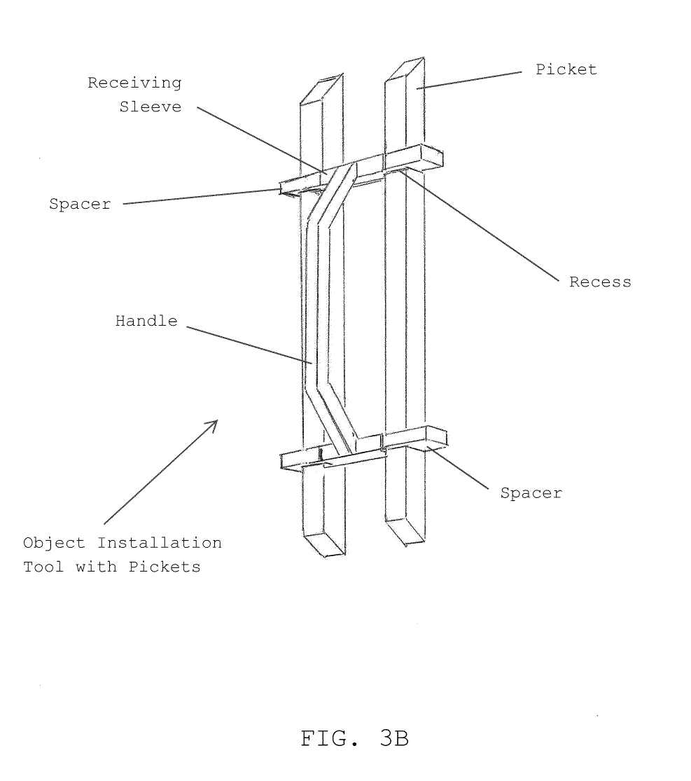

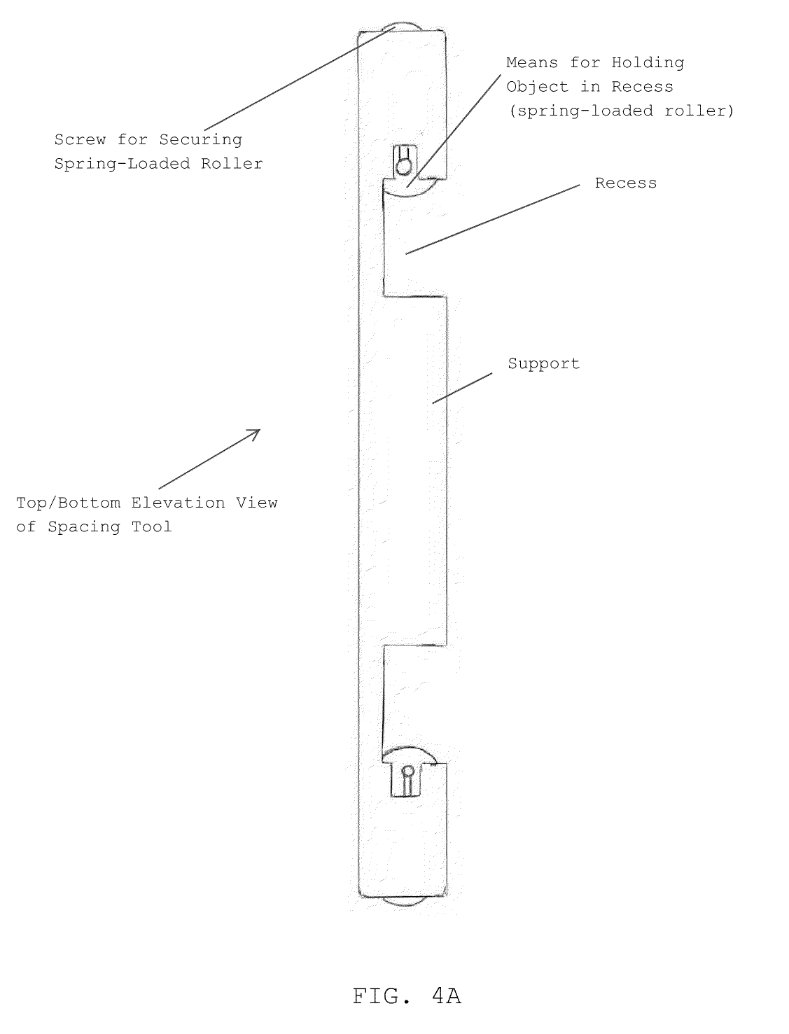

Such a tool allows for quick and easy installation of pickets on deck railings. It potentially can reduce the number of personnel needed to build a deck and reduce the overall time required to complete the job, which both save time and money. A deck railing installed with a picket tool according to the invention is shown in FIG. 2.

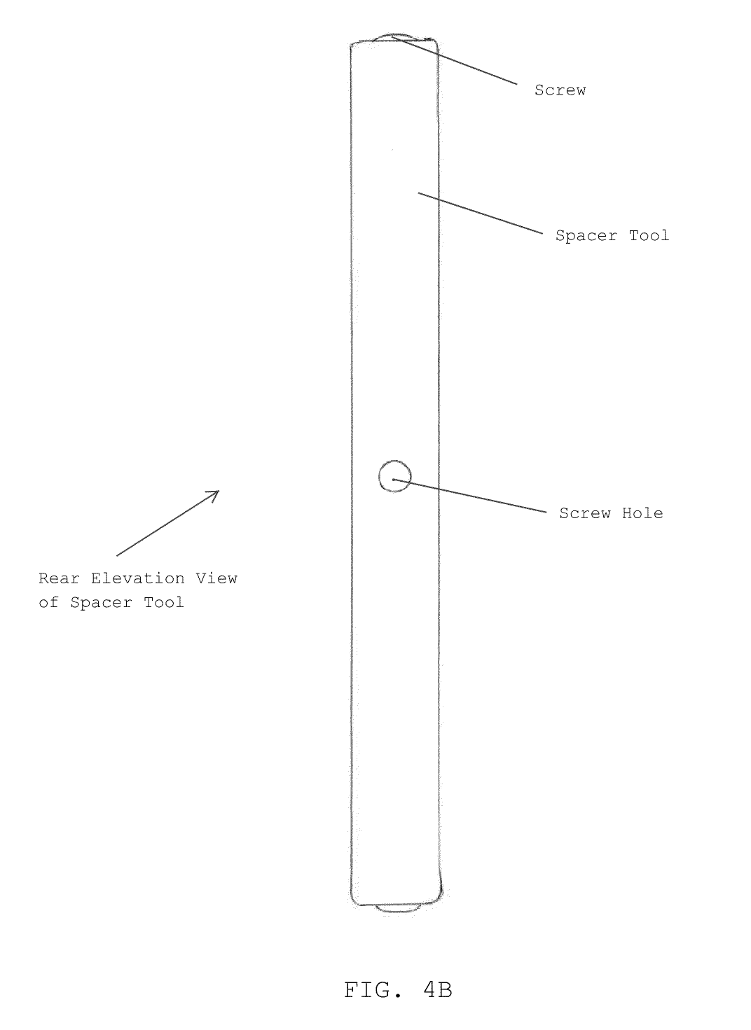

As shown in FIGS. 3A and 3B, there are multiple embodiments for the devices of the invention. FIG. 3A shows the object installation tool designed for cooperation with and for securing to a leveling device. FIG. 3B shows an object installation tool comprising a handle and multiple object spacer/holder means secured to the handle by way of receiving sleeves mounted to the handle at opposite ends of the handle.

The object installation tool of FIG. 3A comprises means for accepting, holding, and spacing an object for installation. As shown, this means can comprise a rectangular bar or block having a rectangular or square cross section. The bar can comprise one or more recesses for accommodating, cooperating with, and gripping one or more pickets. Any number of recesses can be used. Generally, the number of objects that can be installed in rapid succession increases with the number of recesses. The recesses can be spaced at any desired interval and in this embodiment are spaced so as to provide about a 4-inch distance between pickets once installed. This spacing distance is especially suitable for installing residential deck or stair railing pickets because it complies with current national residential construction code. In this embodiment, an optional securing means (such as a bracket or receiving sleeve) is incorporated into or mounted on the bar, which can be used to attach the means for holding the object(s) to another device, such as a pole, other handle, or a level.

The object installation tool of FIG. 3B can be modular (more than one component) or of single-piece construction. As shown, a support or handle can be mounted to receiving sleeves at both ends of the handle or support, so that the receiving means can accommodate and hold the means for spacing/holding the object(s). The overall length of the handle and receiving sleeve combination in this embodiment is approximately 24 inches long, but can be of any desired length depending on the particular application. The tool in this embodiment would be appropriate for installing fence or deck pickets, which are typically 36-42 inches in length. The receiving sleeves can be tubular and rectangular with a square or rectangular cross section, as shown or any appropriate complementary geometry. The tubular receiving sleeves are shaped to accommodate the means for spacing and holding an object, such as that described in FIG. 3A but without the optional means for securing the spacing/holding means to another object, as the receiving sleeve mounted to the handle accomplishes the same purpose. The bar or block shaped means for holding and spacing object(s) can comprise one or more recesses as described above for accommodating and holding pickets. The tool of this embodiment also comprises means for securing the bar to the receiving sleeve, which for example can be any tension-type means for fastening or securing, such as a wing bolt and cooperating hole, or other securing means, including any quick-release type mechanism. Alternatively, the means for holding and spacing objects (bar with recesses, here), the receiving means (receiving sleeve, here), and the handle can be permanently mounted to one another as a one-piece design.

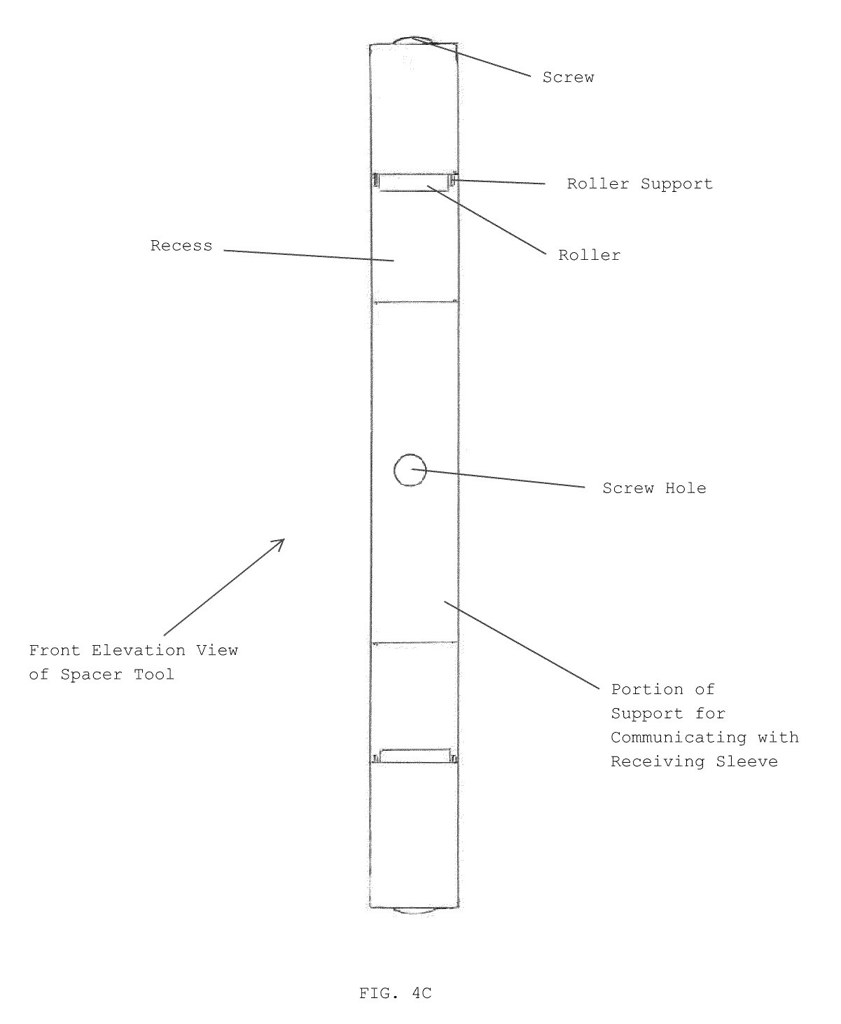

FIG. 4 shows a spacing tool, for example, for installing pickets. The dimensions, shape, or other design elements are not critical and can be adapted for various applications. The spacing tool shown in this embodiment is applicable for installing fencing pickets. As shown in FIG. 4, the object spacing and holding means comprises a support having one or more recesses for accommodating an object (such as a picket), wherein the recesses are spaced a selected distance apart, and comprises means for holding an object within each recess. The means for spacing and holding the object is not limited to a bar with recesses and any equivalent means for accomplishing the same objective would be appropriate. For example, the means for accommodating, holding, and spacing objects can also comprise a support with protrusions, such as clasps, for gripping an object instead of recesses or a combination of recesses and protruding clasps. In this embodiment, the means for spacing and holding an object comprises an overall rectangular shape, approximately 10 inches in length. There are two recesses for holding pickets, each about 1.5 inches wide. The means for holding the objects within the recesses in this embodiment are comprised within each recess. Such means can comprise any know mechanism for temporarily holding the object, such as a spring-loaded roller, as shown. The spring-loaded roller type means for holding the object can also retract into the bar when the picket is inserted into the recess, so that the tool can accommodate objects about the same size as the recess. The spacing/holding means in this embodiment is designed to accommodate pickets up to approximately 1.5 inches wide. The means for securing or holding the object (e.g., a picket) is preferably located within the recess and accommodates pickets of any width up to about 1.5 inches, the size of the recess. In this embodiment, the roller allows for the picket to be easily inserted into and removed from the recess, while providing tension to retain the picket in the recess for so long as desired.

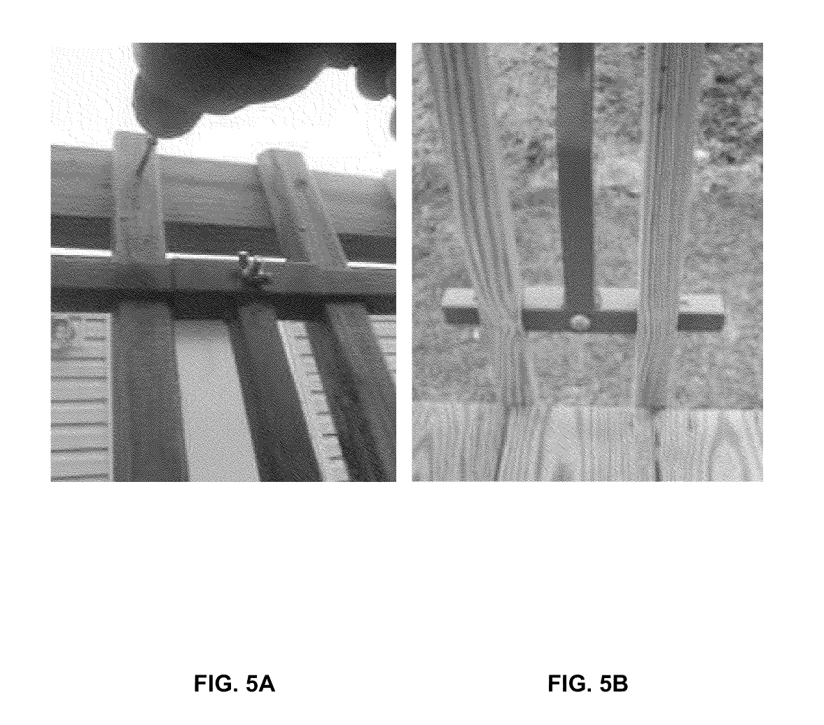

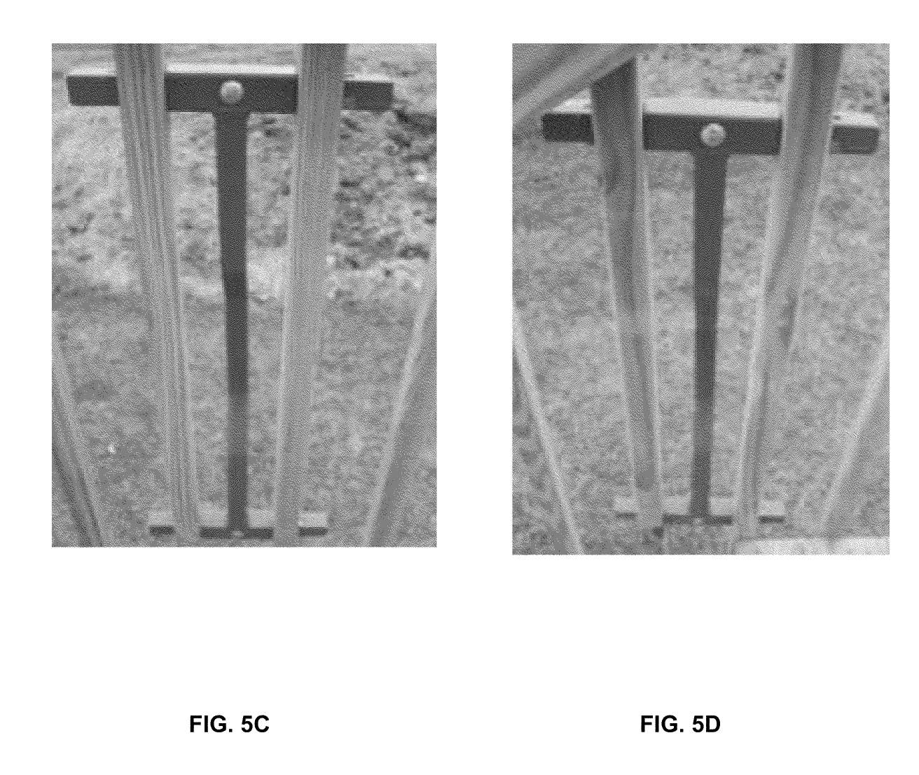

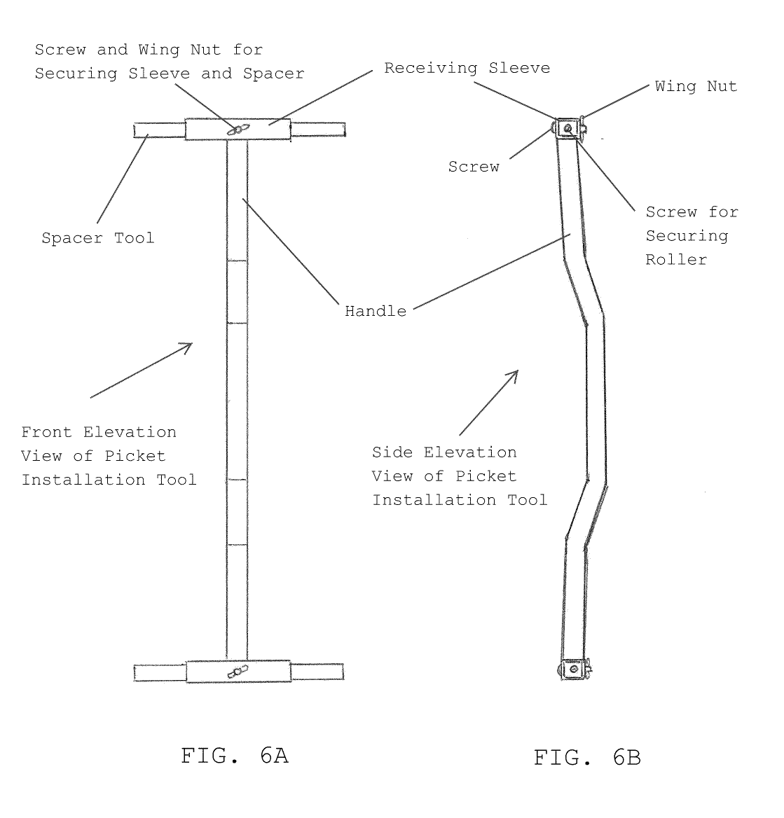

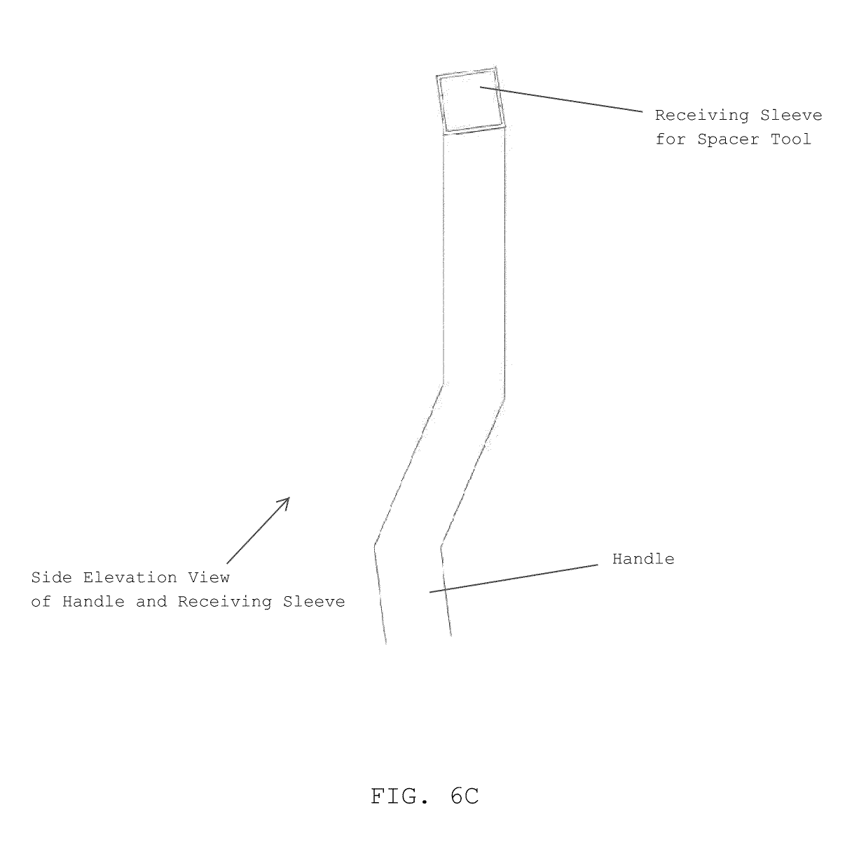

In use, a picket to be installed on a railing can be inserted into one or more of the recesses of the spacing/holding means, leaving one of the terminal recesses available. With the picket(s) held in the recess(es) of the spacer, the tool can then be positioned on an existing picket of a railing (a picket previously installed) by inserting the already installed picket into the remaining recess of the tool, i.e., a terminal recess. The spacing means will then be held in place on the installed picket and will hold all other pickets to be installed in the desired predetermined position without using hands or any other device for holding the pickets in place. With hands free, the installer is capable of using his hands for permanently securing the pickets in place on the railing, such as by using screws and a drill. A photo showing hands-free holding of a picket during installation of the picket is provided in FIGS. 5A-D.

The predetermined spacing interval of the spacing tool need not be a fixed length. For example, the tool can be adjustable and comprise means for adjusting the spacing between the recesses and consequently the spacing between the objects to be installed. One embodiment may comprise a modular spacing tool comprising two supports, one slideably engageable into or with the other, wherein the supports comprise one or more recesses for accommodating an object (such as a picket). For example, in one embodiment, the supports may cooperate with one another in a manner similar to an extension pole, wherein the slideably engageable supports can be pulled apart to achieve a selected distance between the recesses and the distance temporarily fixed by appropriate means. In such an embodiment, the extension pole type similar supports can be twisted to release tension between the cooperating supports, the supports then pulled apart to position the spacing means (e.g., recesses) at the desired positions, and then twisted to apply tension between the supports and temporarily hold the supports so that their recesses are at a desired selected distance. Advantages in this configuration include having the ability to install pickets at varying separation distances, such as 1, 2, 3, 4, or 5, and so on, inches apart without needing more than one tool. Likewise, the tool can also be adjustable lengthwise to accommodate different heights for different applications. Such lengthwise-adjustable tools would be desirable for their applicability in multiple applications so a separate tool is not needed for individual projects.

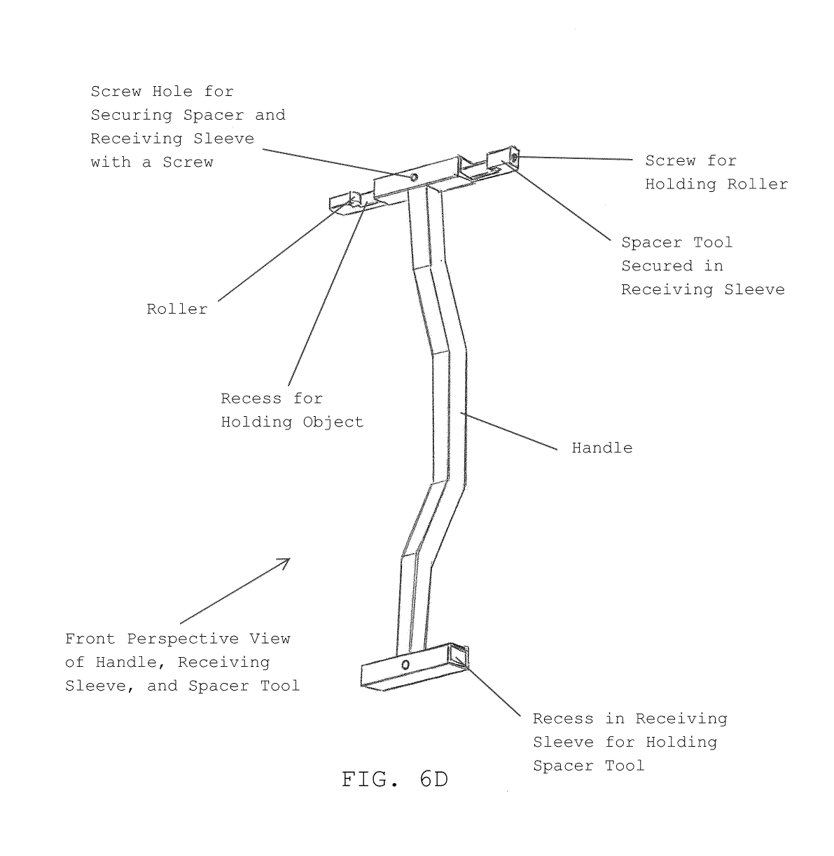

Yet another exemplary embodiment of the object installation tool is shown in FIGS. 6A-D. This series of figures provides details about one embodiment of a tool that can be used to install deck railings. In this embodiment, the overall length of the tool is approximately 24 inches. A tool of this length is short enough to grip the picket, which is typically in the range of about 36-42 inches, and short enough so that the top and bottom of the tool will fit between the railing and floor of the deck while installing the picket. The length of the tool is not critical and can be adjusted according to the dimensions of the object to be installed and/or the dimensions of the workable space available for a particular application. Thus, a picket tool that is about 24 inches in length would be able to accommodate pickets longer than 24 inches and be able to be used in spaces larger than 24 inches in height. Various modifications to the dimensions of the tool can be made according to the desired application.

As shown in FIG. 6A, this embodiment provides an object installation tool about 10 inches in width. The width of the tool is also not critical so long as the tool is wide enough to accommodate the object(s) to be installed, provide for the desired spacing, and fit within the working space provided. The handle for the tool can be attached to a receiving sleeve, which comprises means for receiving the means for spacing/holding the object. Here, the handle and receiving sleeves at either end of the handle are mounted together to provide a single-piece construction, but any number of components can be combined to achieve the same tool, as having a tool that breaks down into components would provide for ease of storing and/or allow for replacement of worn out parts without replacing the entire tool. The receiving sleeve can be a hollow tube comprising a square cross section (as shown) or any equivalent geometry to cooperate with the means for spacing and holding the object(s), which are configured for insertion into the receiving sleeve. The width of the receiving sleeve can be as wide as the desired spacing of the objects to be installed. For example, if pickets are to be installed with 4-inch spacing between pickets (in accordance with code), then the receiving sleeve should be no wider than 4 inches. In a preferred embodiment, the width of the receiving sleeve is about the same as the width of the desired spacing to provide for quick assembly of the tool and proper alignment of the two spacer tools at either end of the handle. The cross-sectional width of the means for receiving the spacing/holding means is slightly larger than the cross-sectional width of the spacing/holding means to allow for ease of insertion of the spacing/holding means into the receiving means. For example, the exterior cross-sectional width of the hollow receiving sleeve can be about 1-¼ inches to about 1-⅛ inches wide, which depending on the thickness of the material used could provide an interior cross-sectional width of the receiving sleeve of about 1 inch to accommodate a spacing/holding means with an exterior cross-sectional width of about 1 inch.

A side view of the object installation tool of this embodiment is shown in FIG. 6B. The handle can be a straight bar, if desired. An advantage exists with a handle having a handle grip that lies in a plane different from the plane of the receiving sleeves, as shown, which allows for more room for a hand to grip the tool during installation, so that a user's hand does not have to fit between the pickets or interfere with the pickets during installation. Any handle that achieves this goal falls within the scope of this invention.

In FIG. 6C, a close up of the handle and receiving sleeve is provided. The handle here shows a rubber hand grip to make use of the tool more comfortable. The angle of bend in the handle to provide a handle grip that lies in a plane different from the plane of the receiving sleeves is also not critical. Any angle that provides for adequate distance between a user's hand and the pickets would suffice to reduce or eliminate interference between the two during installation. Here the bend angle is about 22°. The thickness of the handle is also not critical and may be adjusted according to an overall desired look and feel of the tool. The handle in this embodiment is about 1 inch in exterior cross-sectional width and is welded to the receiving sleeves. The receiving sleeves here are about one and one-eighth an inch to about one and one quarter inch in outside diameter to accommodate a spacer tool of about one inch in outside diameter. A wing bolt is shown here to secure the receiving sleeve and spacer tool together.

FIG. 6D shows a 24-inch object installation tool comprising a handle, two receiving sleeves at opposite ends of the handle, and one spacing/holding means, which is shown accommodated by one of the receiving sleeves and secured by way of a wing bolt in accordance with the specifications provided above with respect to FIGS. 6A-C.

One or more means for leveling the object to be installed (such as a picket) can also be incorporated into the devices of the invention to allow for installation of the object in a position that is level, either or both horizontally or vertically. For example, bubble-type level indicators can be incorporated into or affixed to the devices. Even further, instead of comprising a support bar or handle, the means for spacing the objects to be installed can be adapted for use with an existing leveling device. More particularly, for example, the means for spacing the pickets can comprise a void for engagement with a standard level and means for quickly and easily securing the spacing means device to the level, preferably at either and both ends of the level. The void in the spacing means device is preferably shaped to cooperate with the level being inserted into the spacing means device (picket tool) and most preferably the outline of the level is complimentary to the outline of the void. The means for securing the picket tool to the level can comprise any quick-release mechanism for securing the picket tool to the level, such as for example, a clamp that provides tension, a spring-based tension means, or even a wing bolt and cooperating hole. Any number of spacing means devices can be slideably engaged with the level and secured thereto, in which the level would also provide support to and a handle for the overall device. This configuration has multiple advantages in that manufacturing costs may be lower because fewer materials are needed, potential purchasers may find convenience in using a device that is adapted to fit a level they may already have, and this saves on storage space of the tool because the relatively compact spacing devices (without the support/handle) can be packed and stored in a tool box.

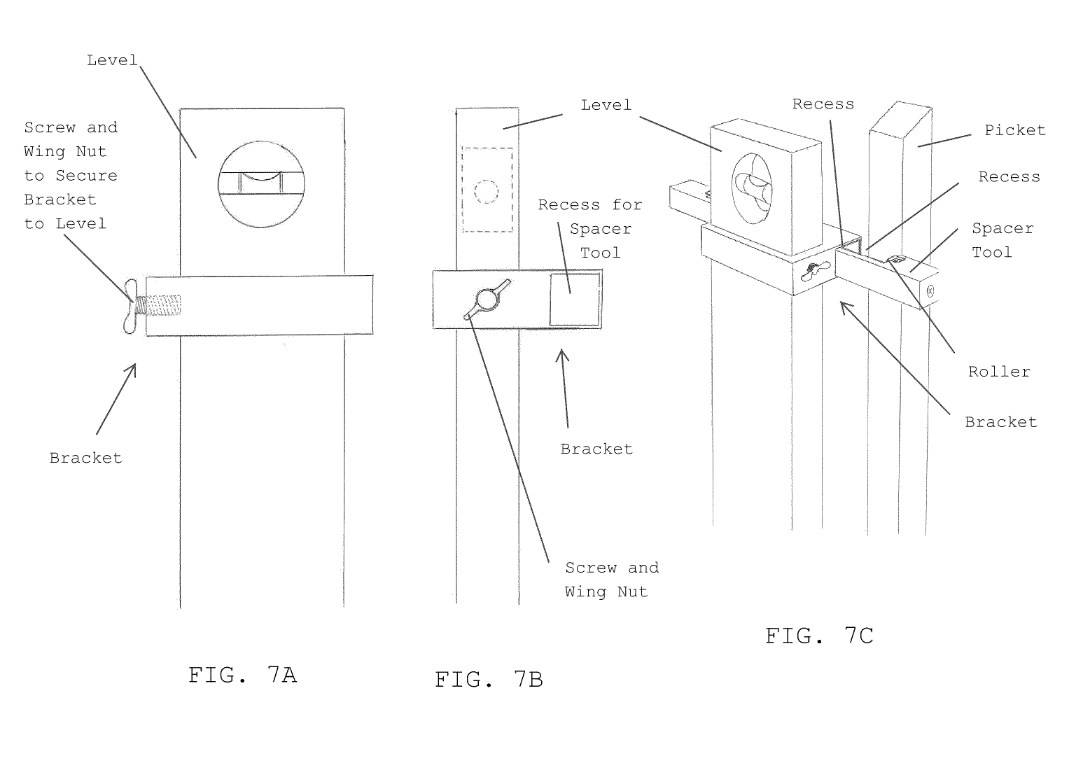

More particularly, an embodiment of this modular type system is provided in FIG. 7. As shown in FIG. 7, the picket tool (spacing means device) can be configured to cooperate with any brand of stick-, block-, or ruler-type level. In this embodiment, the level is a rectangular block-type level comprising bubble-type level indicators at both ends of the level. The picket tool is secured to the level by way of an adapter block. In this embodiment, the picket tool and adapter block are separate components, that is a two-component construction, but the adapter block (or means for securing the picket tool to the level) can be incorporated into the picket tool to provide a single-piece construction. The picket tool if separate from the adapter block comprises means for securing the picket tool to the adapter block. Likewise, the adapter block comprises means for securing the adapter to the level. As shown in FIG. 7, the adapter block comprises two voids, one for cooperation with the level and the other for cooperation with the picket tool, two securing means comprising wing bolts, and two holes for the wing bolts. The void in the adapter for cooperation with the picket tool preferably comprises an outline complimentary to the outline of the picket tool to enhance slideable engagement and attachment of the components.

The tools according to the invention can be made of various materials. Indeed, the materials are not critical and the tools can comprise plastic, metal, or wood to name a few. Advantages can been seen in selecting appropriate materials, which contribute to low cost manufacturing, light-weight tools, and/or sturdy, durable, long-lasting construction. Likewise, one of ordinary skill in the art is capable of recognizing advantages or disadvantages in certain shapes of the components and devices of the invention. For example, an ergonomic handle, rather than a straight handle with a square cross section, could enhance the value of the invention by making the tool more user friendly. Thus, shapes described in this specification can also be adapted in accordance with the application or desired result, modifications which are within the skill of the ordinary artisan.

Further, the invention is not limited to use with pickets for deck railings and fences. The invention can also be used in any application in which hands-free holding capability, consistent spacing, and/or level installation is desired. For example, other applications include installing shelving and shelving systems on walls. In this context in particular, the invention can be used to hold and align shelves and wall support brackets for shelves during installation to provide for hands-free holding of the wall mount or shelf being installed, as well as to achieve a selected spacing of shelves and brackets and assist with installing level shelves. Another application of the invention includes use of the tool for woodworking, such as for building furniture. For example, two of the inventive tools could be used to temporarily hold two boards at a selected distance from one another to allow for securing a third board to the first two, which allows for hands-free holding of the first two boards while installing or securing the third board. Other similar applications are also feasible and within the ordinary skill of the art.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications for a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. A tool for hands-free installation of an object comprising:
means for accepting, holding, and spacing an object at a desired spacing interval.

2. A tool for hands-free installation of an object comprising:
one or more supports comprising one or more recesses for accepting one or more objects,
wherein said recesses and said objects are complementary shaped;
wherein said recesses comprise means for holding said objects within said recesses; and
wherein said recesses are spaced at a desired spacing interval.

3. A tool for hands-free installation of a picket comprising:
two supports each comprising two recesses spaced about 4 inches apart, wherein said recesses comprise means for holding a picket within said recess;
two receiving sleeves each having an interior surface shape complementary to an exterior surface shape of said supports for receiving said supports;
means for securing said supports within said receiving sleeves; and
a handle in communication with said receiving sleeves for maintaining said receiving sleeves and said supports parallel to and at a desired distance from one another.
